(19) United States
(12) Patent Application Publication
(10) Pub. No.: US 2005/0218224 A1
(43) Pub. Date: Oct. 6, 2005

(54) Computerized electronic voting system

(76) Inventor: Anthony J. Boldin, Brookfield, WI (US)

Correspondence Address: GODFREY & KAHN S.C., 780 NORTH WATER STREET, MILWAUKEE, WI, 53202, US

(21) Appl. No.: 10/499,511

(22) PCT Filed: Oct. 22, 2002
(86) PCT No.: PCT/US02/33837

§ 371 Date: Jun. 21, 2004

Related U.S. Application Data
(60) Provisional application No. 60/344,889, filed on Dec. 31, 2001.

(51) Int. Cl. G06F 17/60

(52) U.S. Cl. 235/386

(57) ABSTRACT

The present invention is a computerized electronic voting system that employs an easy-to-use, paperless, voting station to collect and tally votes. In one embodiment, the voting system includes a voting server (12, 52, 62) coupled to a voter security card station (24, 56, 66) and a plurality of voting stations (28, 70). Alternatively, the voting system may include a voting server that is connected to an existing computer network (50) and coupled to a voter security card station. In another embodiment of the invention, the voting system comprises a voting server connected to a plurality of work stations or voting stations and a voter security card station, forming a computer network. The system software installed on the voting server preferably includes a voting application and an administrative application for controlling operation of the voting process. Important aspects of the invention include the ability to print a voter security card for each registered voter at the polling places, the functionality of multiple voting stations running on a single computer or server, and the auditability of voting results.

### CROSS-REFERENCE TO RELATED APPLICATION

This application is based on and claims priority from U.S. Provisional Application Ser. No. 60/344,889 filed Dec. 31, 2001.

### BACKGROUND OF THE INVENTION

The present invention relates generally to a computerized voting system, and more particularly to a computerized electronic voting system comprising a computer with a plurality of voting stations connected thereto for collecting and tallying votes in an election.

Voting systems in place around the world typically involve paper ballots, mechanical machines, punch cards, optical scanning systems, and more recently direct recording voting equipment. These prior art voting systems have proven to be less user-friendly and less reliable than needed to conduct a fair, controversy free election. The controversy surrounding the 2000 U.S. presidential election in Florida forced citizens to recognize that the prior art voting systems are far from state of the art and has spurred efforts to develop easier to use and more reliable voting systems.

The paper ballots used in some areas may be as simple as a form onto which the selected candidates names are written or on which Xs are placed next to the names to indicate the candidate selected by the voter. Alternatively, the paper ballot may have punch holes adjacent the candidate names or ballot issues. There are many disadvantages to paper ballots and punch cards. One is the fact that paper ballots and punch cards can become physically damaged, or altered, between the time the voter makes his/her selections and the time a ballot is counted. Another disadvantage is that voters can inadvertently punch the hole or place an X next to a different candidate than was intended by the voter. In addition, write-in votes must be manually read by an election official, which is time consuming and may be difficult, depending upon the legibility of the voter's handwriting. Also, paper ballots must be custom printed for each election, with at least one ballot printed for each potential voter. Since the ballots are specific to a particular election, the costs for printing ballots for each election may be significant.

Mechanical voting machines include mechanical switches and/or levers which are actuated by a voter to increment one of a plurality of mechanical counters. At the end of the election, the counters for each of the machines at each polling place are tallied and the results are reported to the jurisdictional headquarters. While these machines solve some of the problems associated with paper ballots and punch cards, the machines are fairly expensive and have many mechanical parts which require routine maintenance and repair. In addition, these machines are heavy and cumbersome to move and set up for each election. Another disadvantage is the manual tallying of the counters on the machines at the precincts and the manual reporting of the results to the jurisdictional headquarters.

There are a variety of other non-electronic methods for conducting an election. Unfortunately, each suffer from many of the same problems discussed above, such as illegible ballots which must be discarded, votes inadvertently cast for unintended candidates, excessive costs, and the ease with which the election results may be altered by tampering.

While some electronic voting systems have been developed to solve some of the above mentioned problems, none of the electronic voting systems have been successful enough to result in widespread use.

Some prior art electronic systems include a form of transportable memory, which is used to transport data between the jurisdictional headquarters and the precinct. Other electronic based systems include video displays which present the required ballot information to a voter. Such systems require the voter to scroll through the available options to make their selection. This may be confusing to some voters who may become lost and frustrated in the hierarchy of screen formats, so as not to complete their ballot or to do so erroneously. Other electronic based systems include voting tablets with printed ballot overlays laid on top of the voting tablet. In this case, the voter actuates switches from a matrix of switches to make their selections. Again, this process may be difficult or confusing for a voter to understand.

Another problem with electronic-based systems is the inability to deal with differing ballot styles even within a precinct wherein certain voters may be eligible to vote on certain races and other voters eligible to vote on other races. Most electronic based systems must be manually controlled to provide the proper ballot styles to each voter or the proper combinations selected from among many to provide the correct eligibility for the voter. This places an undue burden on the operators administering the election and presents significant opportunity for error.

Other proposed electronic-based systems include a machine readable card that is given to each voter. The voter must be given the appropriate card for that voter, and then properly place the card in a voting terminal before they can vote. This system may have drawbacks as well, due to the possibility of errors and confusion from using such a system.

Accordingly, there is a need for an improved computerized electronic voting system that makes voting more accessible, is easy to use, more user-friendly, less expensive, and more secure than prior art voting systems.

### SUMMARY OF THE INVENTION

The present invention is a computerized electronic voting system comprising a voting server coupled to a plurality of voting stations and a voter security card station for collecting and tallying votes in an election. The voting system can be configured as a stand-alone system or connected to an existing computer network. The voting system further comprises software that is loaded on the voting server to handle all aspects of the voting process. The software is preferably comprised of a voting application and an administrative application.

The voting server is a computer that preferably comprises a motherboard with at least one processor and memory, at least one hard drive, a disk drive, a plurality of video boards, and a power supply installed within a computer enclosure or processing box. The processor must be sufficient to support the plurality of voting stations at one time. The video boards offer simultaneous control of the plurality of voting stations while functioning independently of each other. The voting system is also equipped with a software key to prevent the software from running without the key properly installed on the computer or a hub coupling the system components together.

The plurality of voting stations are preferably comprised of touch screen monitors that voters use to enter their votes into the system. The voting stations may also be comprised of computer work stations or regular monitors with pointing devices and/or keyboards connected thereto for inputting voting selections. Voters use the voting stations to log onto the system and cast their votes. When a ballot is cast, a snap shot of the ballot content is stored in a database on the hard drive and is written to a removable disk in the disk drive. In addition, all election data totals and summaries are stored in a database and backed up on a removable disk.

The voter security card station preferably comprises a personal identification number (PIN) printer, a PIN generation device, and an optional touch screen monitor. The PIN printer and PIN generation device are used by election officials to create and print voter security cards for registered voters wanting to vote in an election. A registered voter must obtain a voter security card prior to using the voting system of the present invention. The voter security cards include a unique voter number and PIN for each registered voter to log onto the system and vote. The PIN printer is also used to print opening and closing election reports.

In one embodiment of the present invention, the voting system is a stand-alone system with a voting server connected to a plurality of voting stations and a voter security card station.

In another embodiment, the voting system includes a voting server that may be connected to an existing computer network and coupled to a voter security card station. When the voting server and system software is coupled to the existing network, the work stations of the network become voting stations. The voting stations are preferably comprised of existing computer workstations including computers, monitors, keyboards, and pointing devices that voters use to enter their votes into the system. Alternatively, the voting stations may be comprised of computers and touch screen monitors.

In yet another embodiment of the present invention, the voting system comprises a voting server connected to a plurality of work stations or voting stations and a voter security card station, forming a computer network. This comprehensive computer network can not only be used for voting purposes, but can also be used for normal business applications. When not being used for voting, the computer equipment can be used as regular computer work stations.

Yet another embodiment of the present invention provides voting access to the disabled through a mobile voting system or a stationary voting system. The mobile voting system preferably comprises a laptop computer electronically coupled to a voting server or run from software on a removable disk. The stationary voting system preferably comprises a single computer coupled to a voting server or run from software on a removable disk. These systems further include an input device and a speech recognition device coupled to the computer. This embodiment provides any combination of normal viewing, touch screen voting, keypad voting and speech recognition functionality depending on an individual voter's needs. For example, a voter may use speech recognition and voice navigation, speech recognition and keypad navigation, normal viewing and keypad navigation, or normal viewing and voice navigation all in the same system. All speech recognition commands are ambiguous, allowing for confidential and private voting. As mentioned above, the system can be developed as a mobile unit for curb-side voting, etc., or as a stationary unit, providing full integration with the voting system of the present invention.

Alternative embodiments of the present invention include a ballot server offered over the Internet, and an absentee voting process. In the embodiment of the ballot server offered over the Internet, registered voters would receive a unique URL and PIN to connect to a ballot from the ballot server. The voter would then go through the same interface as in the previous embodiments and casts the ballot with the voting selections stored electronically and sent to the elections office to be recorded and validated electronically. In the absentee voting process, a registered voter would request an absentee ballot from the local elections office. The elections office would send the registered voter a unique URL and PIN for the voter to log onto the system and access a ballot. The voter would then go through the same interface as in the previous embodiments. The completed ballot is securely encoded and printed by the voter. The voter send the completed ballot to the elections office, which scans the ballot and counts the votes using the system software. The completed ballot results are stored in memory and on a removable disk.

The system and method of the present invention provides all functions necessary to set-up, open, operate and close an election. For each election, electronic ballots are created and delivered on a removable disk for installation on the voting system at the polling locations. The voting application presents a ballot to a voter through a series of screens, one screen for each race in the election. To make a selection, a voter simply touches or selects an option button next to the selection. After voting is complete, the voter can review and modify all of his/her selections prior to casting his/her final vote. Easy to use only one contest per screen, easy to follow and understand, step through voting process using voting screens, still have the opportunity to review selections and make changes before officially casting their ballots. A voting interface contains features that can be defined as part of the ballot. The interface provides the option of making a straight party vote, an abstain option for any and all races, allow selection of multiple candidates in a single race, provide a write-in option for any or all races, which allows a voter to manually enter a name as a selection. An administrative application provides election monitoring functions allowing election officials to access administrative functions of the system at any time by logging on to a voting station with an administrator password. The system also prepares election reports before and after the election.

The present invention provides enhanced flexibility and a cost savings from prior art voting systems by utilizing common computer components that have multiple uses and are less expensive than specialized hardware of prior art voting systems. No additional hardware needs to be purchased. Any computer system can become a voting system. Use computer system year round, use voting system only during elections. The voting system can be incorporated into commonly used computers or networks. In fact, the hardware components of the present invention may be used as normal everyday computers for most of the year and used as a voting system only during elections. The software may be loaded onto the system and used only when needed. The present invention also provides enhanced security based on an audit tool that allows administrators to validate cast ballots.

Important aspects of the invention include the ability to print a voter security card for each registered voter at the polling places, the functionality of multiple voting stations running on a single computer or server, and the auditability of voting results.

Auditability is ensured by the system capturing the screen image of each actual vote and storing it on a hard drive and a removable disk so the stored image can be compared to what is in the database to assure that what was “on-screen” was actually what is tabulated in the database. When a voter touches the “Cast Ballot” or “Print Ballof” buttons, the software takes a visual snapshot of the ballot and stores the images in memory. An exact image of each vote is stored on a hard drive and a removable disk. Voting data, as opposed to the image, is also written simultaneously to a hard drive and a removable disk installed in the disk drive. The voting results are tabulated on the removable disk so the final results can be tallied. Individual disks from the different voting locations are taken to a central location for tallying the results for a precinct, county or state, etc. Election data for scanning can also be printed out if the municipality requires hard copies of voter ballots.

Various other features, objects, and advantages of the invention will be made apparent to those skilled in the art from the accompanying drawings and detailed description thereof.

### BRIEF DESCRIPTION OF THE DRAWINGS

FIG. 1 is a diagram of the main components of one embodiment of the voting system of the present invention;

FIG. 1A is an installation diagram of the components of the voting system of FIG. 1;

FIG. 2 is a diagram of the main components of another embodiment of the voting system of the present invention;

FIG. 3 is a diagram of the main components of yet another embodiment of the voting system of the present invention;

FIG. 3A is an installation diagram of the components of the voting system of FIG. 3;

FIG. 4A is a diagram of the main components of a mobile voting system for disabled voters in accordance with the present invention;

FIG. 4B is a diagram of the main components of a stationary voting system for disabled voters in accordance with the present invention;

FIG. 5 is a flow diagram of an absentee voting process in accordance with the voting system of the present invention;

FIG. 6 is a diagram of the software architecture of the voting system of the present invention;

FIG. 7 is a diagram of the system interfaces of the voting system of the present invention;

FIG. 8 is a sample screen shot of the voting screen areas provided on the voting stations of the present invention;

FIG. 9 is a sample screen shot of the begin screen provided on the voting stations of the present invention;

FIG. 10 is a sample screen shot of the welcome screen provided on the voting stations of the present invention;

FIG. 11 is a sample screen shot of the voter number login screen provided on the voting stations of the present invention;

FIG. 12 is a sample screen shot of the PIN number login screen provided on the voting stations of the present invention;

FIG. 13 is a sample screen shot of the administrative login screen provided on the voting stations of the present invention;

FIG. 14 is a sample screen shot of the keyboard screen provided on the voting stations of the present invention;

FIG. 15 is a sample screen shot of a straight party ticket screen provided on the voting stations of the present invention;

FIG. 16 is a sample screen shot of a contest selection screen provided on the voting stations of the present invention;

FIG. 17 is a sample screen shot of a race selection screen provided on the voting stations of the present invention;

FIG. 18 is a sample screen shot of a ballot screen provided on the voting stations of the present invention before completing the ballot;

FIG. 19 is sample screen shot of another ballot screen provided on the voting stations of the present invention after completing the ballot;

FIG. 20 is a sample screen shot of the basic administration screen provided on the voting stations of the present invention;

FIG. 21 is a sample screen shot of the advanced administration screen provided on the voting stations of the present invention;

FIG. 22 is a sample screen shot of the change administrator password screen provided on the voting stations of the present invention;

FIG. 22A is a sample screen shot of the configuration screen for changing the administrator passwords provided on the voting stations of the present invention;

FIG. 23 is a sample screen shot of the totals and summary screen provided on the voting stations of the present invention;

FIG. 24 is a sample screen shot of the voter security card generator screen provided on the voting stations of the present invention; and

FIG. 25 is a sample screen shot of the view log screen provided on the voting stations of the present invention.

### DETAILED DESCRIPTION OF THE INVENTION

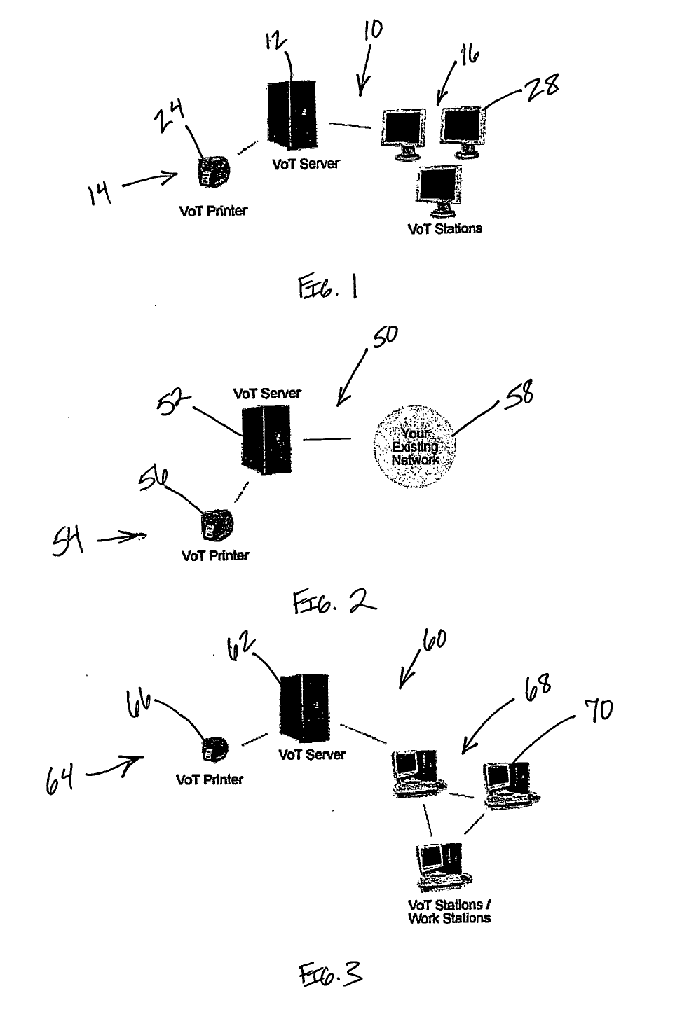

Referring now to the drawings, FIGS. 1-3, 4A and 4B show different embodiments of the voting system of the present invention. FIGS. 1 and 1A illustrate one embodiment of a voting system 10 of the present invention. A voting server 12 is preferably connected to a voter security card station 14 and a plurality of voting stations 16. The voter security card station preferably comprises a voter security card printer 24. The plurality of voting stations 16 preferably comprise a plurality of touch screen monitors 28. The plurality of monitors 28 connected to the voting server 12 work independently of each other. This occurs by having a single software application that acts as a virtual internal server that accepts inputs from each voting station and send outputs to the appropriate voting station. The number of voting stations are limited only by the number of PCI slots in the processing box where a video board for a monitor can be installed and the capabilities of the processor or processors.

The voting stations 16 of the first embodiment are preferably comprised of touch screen monitors 28 that voters use to enter their votes into the system. Each of the touch screen monitors 28 are used by a voter to cast a ballot. When a vote is cast, the ballot content is stored in a database on the hard drive, as well as being written to a removable disk in the disk drive. In addition, all election data totals and summaries are stored on the hard drive and backed up on a removable disk. The voting stations 16 may also comprise regular monitors with input devices and/or keyboards connected thereto for inputting voting selections.

FIG. 1A shows an installation diagram of the hardware components of one embodiment of the voting system 10′ of the present invention. In this embodiment, the voting system 10′ preferably includes a single processing box or computer 12′, a voter security card station 14′, and a plurality of voting stations 16′. The processing box 12′ preferably comprises a motherboard with at least one processor and memory, at least one hard drive, a disk drive, a power supply, and a plurality of video cards. The plurality of video cards are installed within expansion slots in the processing box 12′. The voter security card station 14′ and plurality of voting stations 16′ are preferably connected to the computer 12′ either directly or via hubs 22. The voter security card station 14′ preferably comprises at least one PIN number printer 24′, a PIN generation mouse 26, and possibly a touch screen monitor 28′. The PIN number printer 24′ and PIN generation mouse 26 are used to create voter security cards, each with a unique voter number and PIN number for a voter to log onto the system and vote. A voter must obtain a voter security card in order to use the system. Election officials use the PIN number printer 24′ and PIN generation mouse 26 to print voter security cards for each registered voter and print election reports.

The system generates pre- and post-election reports using the system's administrative functions and PIN printer. The reports include opening vote counts and closing vote counts. Prior to each election, the system prints a report showing zeros for each candidate in each race. At the end of each election, the system prints a report showing the vote totals for each candidate in each race.

The plurality of voting stations 16′are preferably made up of touch screen monitors 28′. The processing box 12′ is preferably coupled to a UPS power supply backup 34, which is plugged into a 120V electrical outlet. The touch screen monitors 28′ are preferably coupled to the processing box 12′ with video cords 36. The touch screen monitors 28′ also each have a USB interface that is coupled to a USB hub 22. The monitors 28′ also have power cords 38 that plug into 120V electrical outlets.

Specifically, the video connections include I/O video signals through video cords 36 connected from the video cards installed in the processing box 12′ to the monitors 28′, and user inputs sent directly from each monitor's touch screen controller via a USB cable 40 connected to a USB hub 22 that is connected to the processing box 12′. The PIN number printer 24′ is connected to the processing box 12′ through a printer cable 42 and is connected to a 120V outlet with a power cord 38. The PIN generation mouse 26 is connected to one of the USB hubs 22 through a USB cable 46. A software key 32 is preferably plugged into a USB port on one of the USB hubs 22 for security. The software key 32 prevents the system from operating if the key is not plugged into a USB port on one of the USB hubs and turned on.

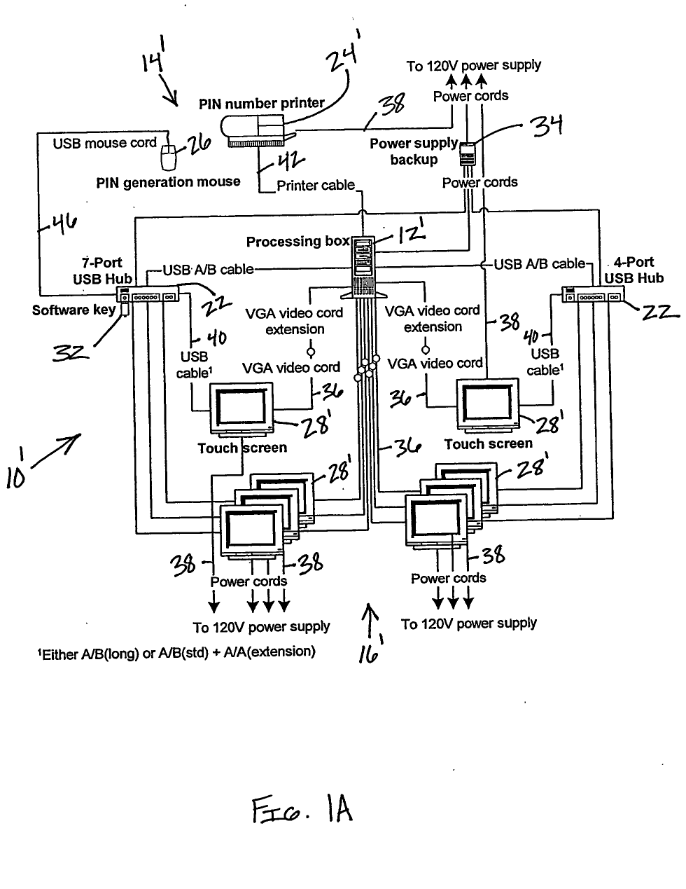

FIG. 2 shows another embodiment of the voting system 50, which includes a voting server 52 connected to a voter security card station 54 and an existing network 58. The voter security card station 54 preferably comprises a voter security card printer 56. The existing network preferably includes a plurality of computer workstations that become voting stations when connected to the voting server 52 running the system software. The existing computer workstations preferably include computers, monitors, keyboards and input devices that voters use to enter their votes into the system. The data on the existing network 58 is safe because the system software disables the local server and interacts only with the voting server.

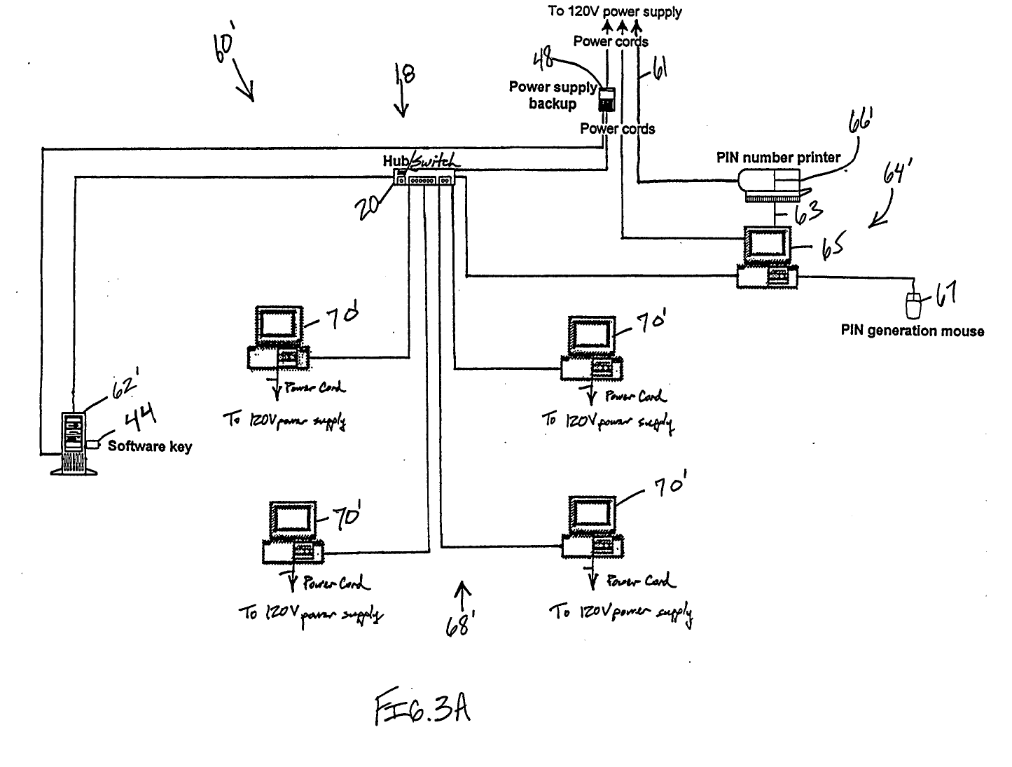

In another embodiment shown in FIG. 3, the voting system 60 includes a voting server 62 connected to a plurality of voting stations 68 and a voter security card station 64. The plurality of voting stations 68 are preferably comprised of computer workstations 70, including computers, monitors, keyboards and input devices that voters use to enter their votes into the system. Alternatively, the work stations 70 may be comprised of computers and touch screen monitors.

FIG. 3A shows an installation diagram of the hardware components of the voting system 60′ of the present invention. The voting system 60′ is preferably coupled to a voter security card station 64′ and a plurality of voting stations 68′. The voting system 60′ preferably includes a voting server 62′ connected to a plurality of computer workstations 70′, also known as voting stations 68′, a PIN generation mouse 67, a PIN number printer 66′, at least one hub 20, a software key 44, a UPS power supply backup 48, and various cables and cords. The voting server 62′ is coupled to the UPS power supply backup 48, which is plugged into a 120V electrical outlet. The voting stations 70′ are coupled to the server 62′ and at least one hub 20. The server 62′ and voting stations 70′ also each have power cords that plug into 120V electrical outlets. The PIN number printer 66′ is preferably connected to a computer 65 through a printer cable 63 and is connected to a 120V outlet with a power cord. The PIN generation mouse 67 is connected to the same computer 65 and combined with the PIN number printer 66′ to make up the voter security card station 64′. The software key 44 is plugged into a port on the server 62′ and prevents the system from operating if the key is not properly connected to the server and turned on.

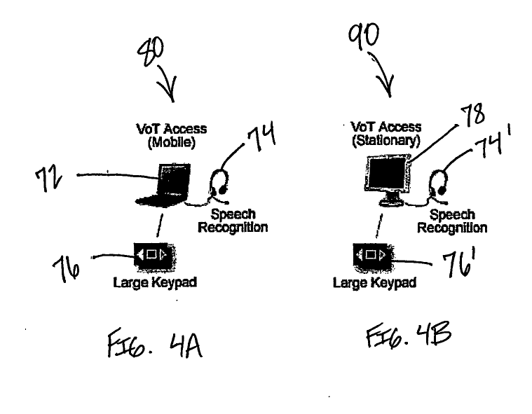

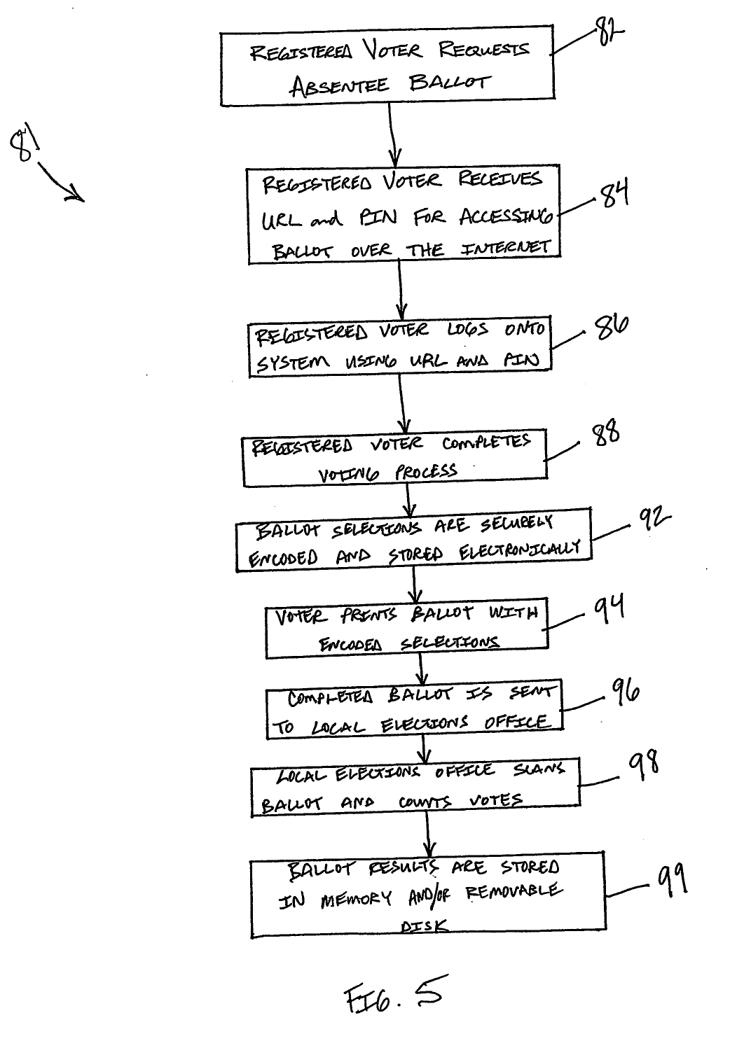

FIGS. 4A and 4B illustrate yet another embodiment of the present invention. This embodiment provides voting access to the disabled through a mobile voting system 80 or a stationary voting system 90. The mobile voting system 80 preferably comprises a laptop computer 72 electronically coupled to a voting server or run from software on a removable disk. The stationary voting system 90 preferably comprises a single computer or touch screen monitor 78 coupled to a voting server or run from software on a removable disk. These systems further include an input device 76, 76′ and a speech recognition device 74, 74′ coupled to the computer. This embodiment provides any combination of normal viewing, touch screen voting, keypad voting and speech recognition functionality depending on an individual voter's needs. For example, a voter may use speech recognition and voice navigation, speech recognition and keypad navigation, normal viewing and keypad navigation, or normal viewing and voice navigation all in the same system. All speech recognition commands are ambiguous, allowing for confidential and private voting. As mentioned above, the system can be developed as a mobile unit for curb-side voting, etc., or as a stationary unit, providing full integration with the voting system of the present invention.

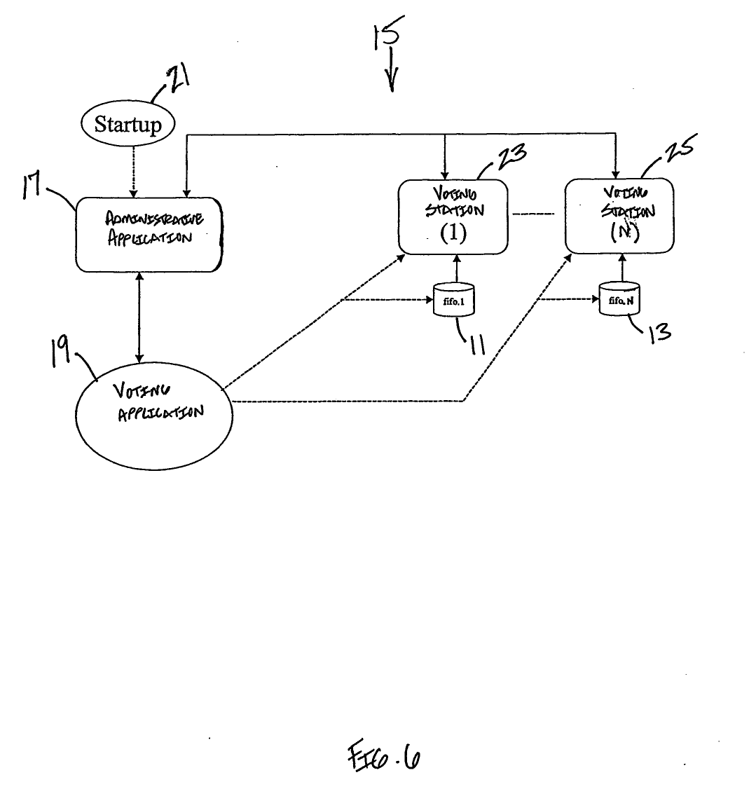

FIG. 5 illustrates an absentee voting process 81 of the present invention. First, a registered voter would request an absentee ballot from the local elections office 82, the voter would then be mailed or e-mailed a URL and PIN for accessing the ballot server over the Internet 84. A voter could then log onto the server using the URL and PIN to access the correct ballot from the ballot server 86. The voter goes through the same user interface as previous embodiments, however, the last screen changes from “Cast Ballot” to Print Ballot” 88. The results are securely encoded with a bar code or other equivalent coding scheme that stores the voter's choices electronically 92. The voter then prints the finished ballot with the encoded selections 94, and mails or e-mails the ballot back to the local elections office 96. The local elections office scans the ballot and counts the votes with the system software 98. The ballots are stored in memory and on a removable disk 99.

An alternative embodiment of the present invention includes a ballot server offered over the Internet. In this embodiment, registered voters would receive a URL and PIN to connect to proper ballot from ballot server, voter goes through same interface as in previous embodiments, voter casts ballot with choices stored electronically and sent to precinct to be recorded and validated electronically. In the embodiment of the ballot server offered over the Internet, registered voters would receive a unique URL and PIN to connect to a ballot from the ballot server. The voter would then go through the same interface as in the previous embodiments and casts the ballot with the voting selections stored electronically and sent to the elections office to be recorded and validated electronically.

The software platform loaded on the voting server handles all aspects of the voting process. It is composed of four primary components. A “Ballot Builder” provides a simple interface for election officials to generate ballots using a step-by-step wizard. A “Tally Tool” allows election officials to tabulate election results for each voting station into a single consolidated report. The results can then be utilized for official results within an “Election Reporter,” or exported to any standardized format, such as Microsoft Excel spreadsheets or XML files. The “Election Reporter” allows election officials to tally absentee ballots and add them to the final election results. The results can then be officially printed for review. An “Audit Tool” provides detailed analysis of all election results, to include viewing screen captures at the time of voting to ensure ballot integrity, and allows administrators to validate cast ballots. When a voter selects the “Cast Ballot” button or “Print Ballot” button with absentee ballots, the software takes a visual snapshot of the ballot. With the images stored in a database, administrators can handle recounts or contested races.

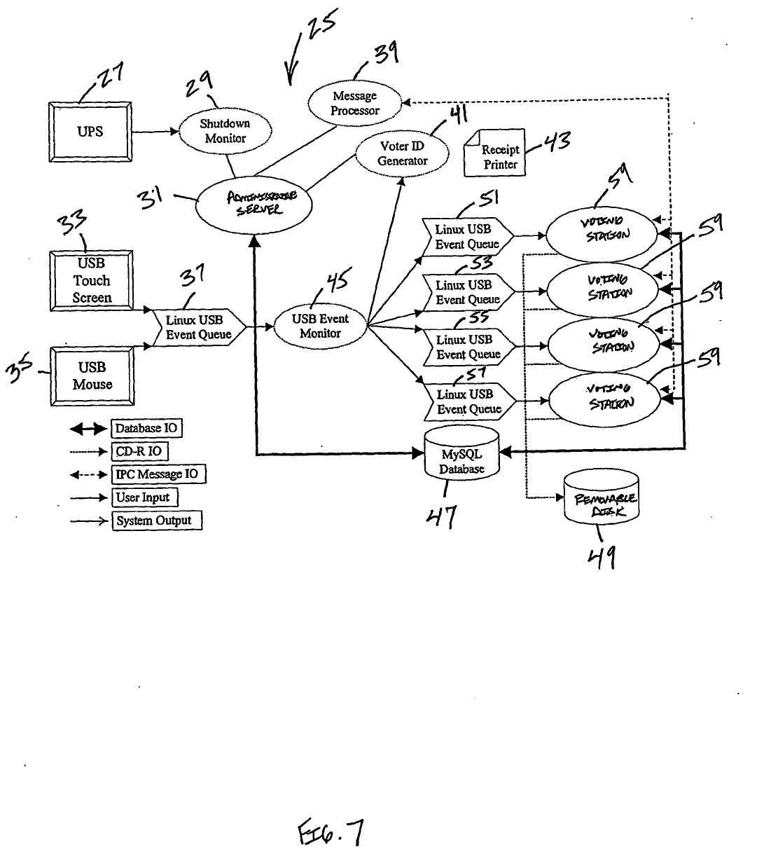

FIG. 6 shows a diagram of the software architecture of the voting system of the present invention. The system software includes a startup program 21, an administrative application 17 and a voting application 19 for conducting an election on voting stations 23, 25 through interfaces 11, 13. The software is divided into two distinct functional areas, an administrative function used by election officials and a voting function used by voters. The administrative application comprises the setup functions, opening functions, monitoring functions, and closing functions that are accessible only by election officials. Whenever necessary, election officials are able to access the administration functions of the system with administrator passwords. The voting application program comprises the ballots and voting functions used by voters to enter their votes into the system.

The software is based generally on client/server network concepts. The software comprises a startup program, an application program, a database to store ballot information and vote totals, a first shared library program to handle the software key that holds the protective counter and is required to use the system, a second shared library program to process system server operations requests, and a serial communication library program for communicating with the other components of the system.

As mentioned above, the software is comprised of a voting application 19 and an administrative application 17. Several small programs function to start, stop and control the system at the operating level. The voting application and multiple voting station communication software are preferably included in a single large Java application program. The application architecture involves an administrative server preferably operating in a Linux environment that pulls files from an administrative library, thereby loading a plurality of the application programs into the individual voting stations. Each application program controls the interaction of a single voting station and communicates information obtained back to the administrative server. The voting application that is loaded from the administrative library includes all the necessary functionality to successfully conduct an accurate election. Two integrated applications are contained in the administrative library. The first is a secure administrative application that provides all of the functions necessary to open, operate and close the polls for voting. The second application allows a user to securely log on, enter, review and cast their votes for contested elections.

The software also preferably includes a password security system to ensure the security of the ballots and restrict access to the system to only those people with passwords. Passwords only allow access to specific portions of the system. Three levels of passwords are implemented in the system to insure system security.

The voting application is accessible with a voter security card having a unique voter number and PIN combination for each registered voter. Election officials at the polling place must confirm that each voter is registered in the proper area prior to issuing and printing the voter security card for each registered voter. The voter security card includes a unique voter number and PIN combination for each registered voter. The unique voter number and PIN combination is specific to the ballot for which it is generated, and can be used only once. Once a voter obtains a voter security card, he/she can use the unique voter number and PIN combination printed on the card to log into the system and cast one ballot. Election officials are required to verify that a voter is registered prior to issuing and printing the voter security cards.

Election officials can use a password to access the administrative functions from the touch screen in any voting station. Before voting begins, election officials use the administrative functions to set up the system for voting and create the opening election report. When the polling location is opened, election officials can access the administrative functions to get a ballot count, run troubleshooting functions, or close the polls. After voting is finished and the polling place is closed, election officials use the administrative functions to create the closing election report.

A basic administrator password allows access of election officials to two troubleshooting functions, recalibrate screen and print card. The basic administrator password allows access to limited administrative functions, including touch screen re-calibration, and voter security card generation. Any election worker can be given the basic administrator password. This basic administrator password can be given to any election worker who might need to perform these troubleshooting functions during voting. The advanced administrator password allows an election official to access all administrative functions, including the ability to open the polls, begin the voting process, import election ballots, view the system log, reset voting stations, end voting, and close the polls. In general, the advanced administrator password is held only by the chief election officer, or the person in charge of the polling place. The chief election official in charge of the election is issued an advanced administrator password. This password allows access to all administrative functions, and also must be entered whenever the polls are opened or closed, when a ballot is imported, or when the system is reset or shut down.

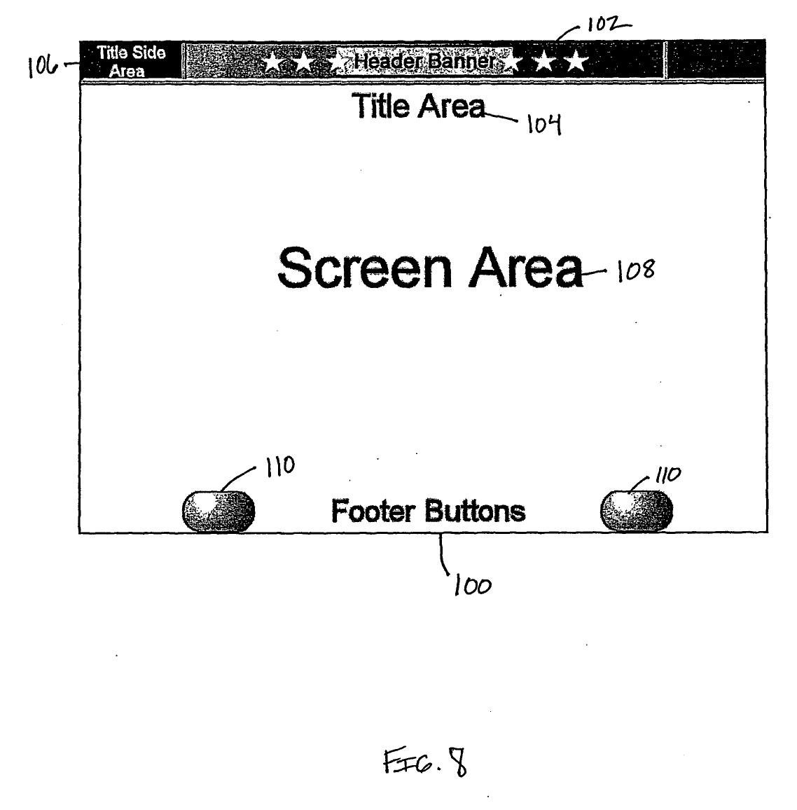

FIG. 7 shows a diagram of the system interfaces 25 of an embodiment of the voting system of the present invention. The hardware and software system interfaces shown include database 110 between the administrative server, database and client servers; I/O from the client servers to a removable disk; IPC Message I/O between a message processor and the client servers; user input from the hardware components; and system output.

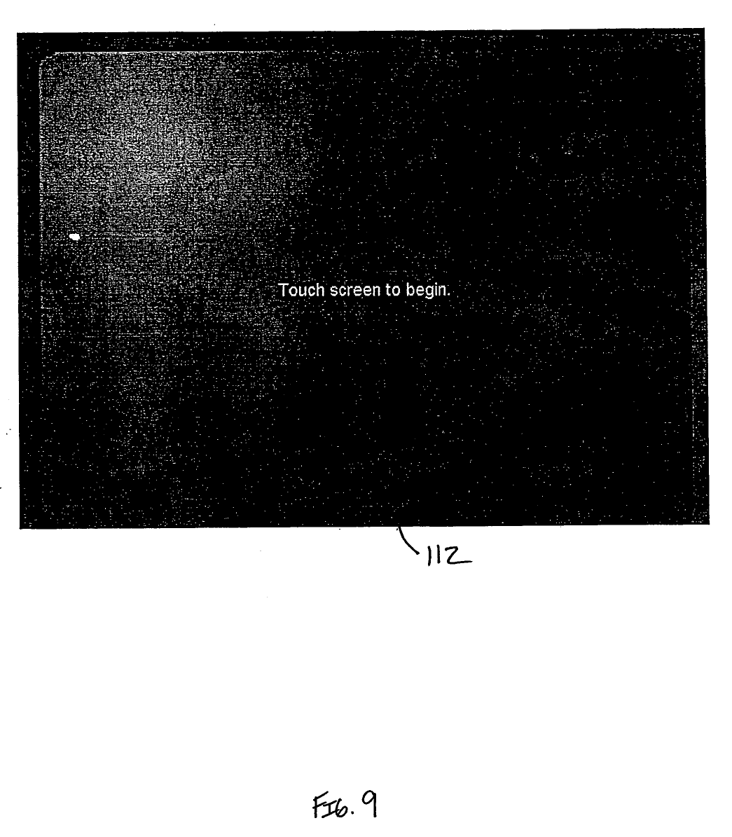

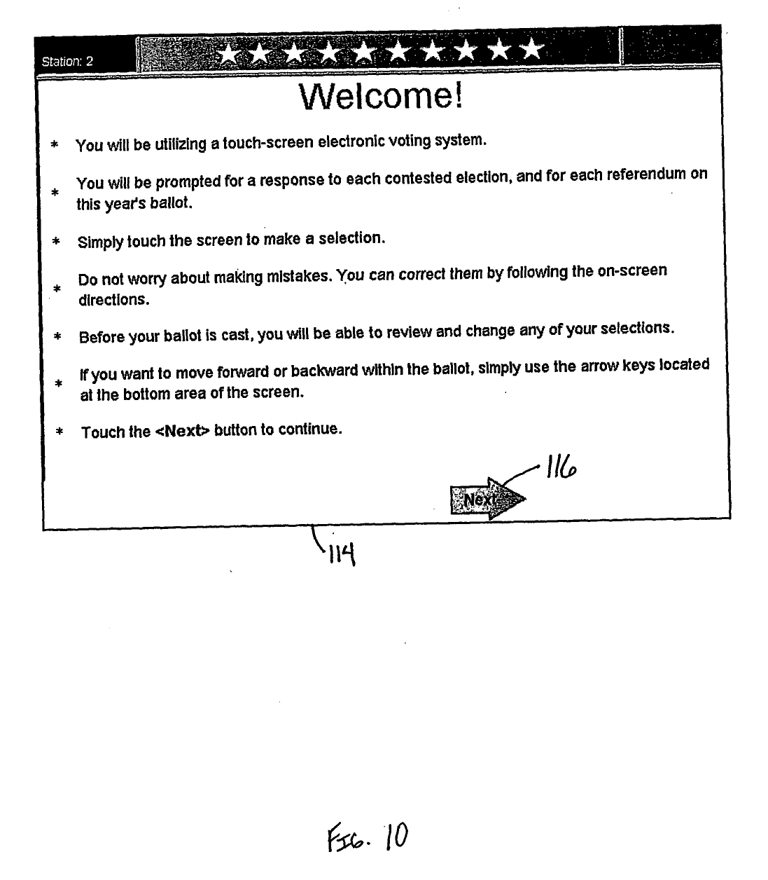

FIG. 8 shows the common screen format interface for both the voting application and the administrative application of the present invention. The screen 100 is composed of a header banner 102, a title area 104, a title side area 106, a screen area 108, and footer buttons 110. The startup screens, which include the start screen, initialization screen, calibration screen and begin screen, are not divided into regions as depicted in FIG. 8, but appear as solid screens with text to identify the screen. An example of a begin screen 112 is shown in FIG. 9.

FIG. 9 is a sample screen shot of the begin screen 112 provided on the voting stations of the present invention. The begin screen 112 serves as a splash screen prior to voter login. It provides an easy indication of whether a voting station is prepared for a new voter. When a touch screen is employed, a user can touch anywhere on the begin screen 112 to display a welcome screen 114.

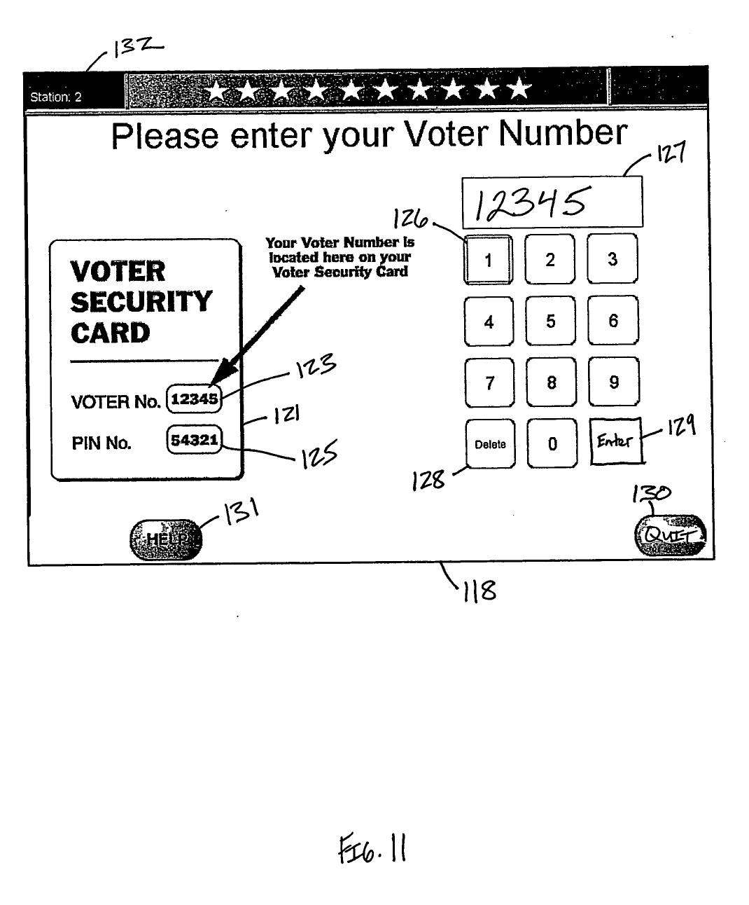

FIG. 10 is a sample screen shot of the welcome screen 114 provided on the voting stations of the present invention. The welcome screen 114 is displayed when a user first accesses the voting application. The welcome screen 114 contains instructions for using the system to cast votes and complete a ballot. The only action a voter can take on this screen is to select Next 116 to go to a voter number login screen 118.

The system preferably includes three login screens, a voter number login screen 118, a PIN number login screen 122, and an administrative login screen 124. These login screens are used by voters to access a ballot, or by election officials to access administrative functions.

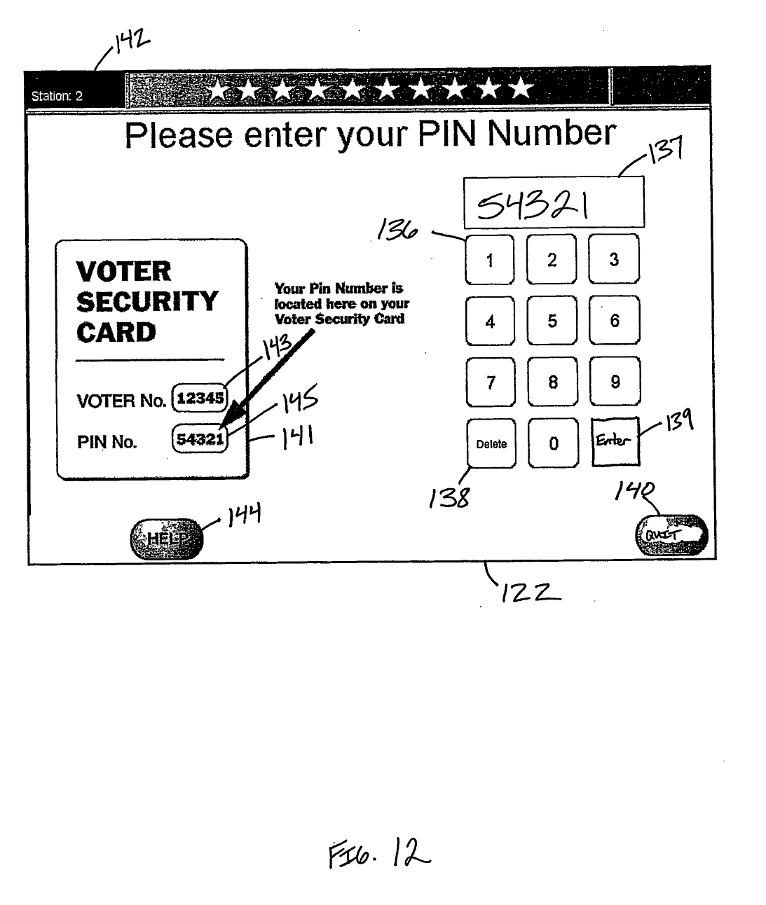

FIG. 11 is a sample screen shot of the voter number login screen 118 provided on the voting stations of the present invention. The voter number login screen 118 is where a voter enters the voter number from his/her voter security card into the system in preparation for voting. A sample voter security card 121 is displayed on the voter number login screen 118. The voter security card 121 includes a unique voter number 123 and PIN number 125 that is issued to the voter by election officials when the voter entered the polling place and has his/her voter registration verified. Preferably, on the voter number login screen 118, a voter can select one of the number buttons 126 to enter a number in the entry field 127, select Delete 128 to erase the last digit in the entry field 127, select Enter 129 to process the number in the entry field 127, select the title side area 132 to display the administrative login screen 124, select Help 131 to go to the system help screen, or select Quit 130 to end the voting session. After the voter selects Enter 129, the system checks the number in the entry field against the generated voter numbers stored in the database to determine if the number entered is a valid voter number. If it is a valid voter number, the system records the number for comparison to the PIN number the user will enter on the next screen. The system then displays a PIN number login screen 122. If it is not a valid voter number, the system clears the entry field and displays an error message box. When the user selects Ok, the system closes the error message box.

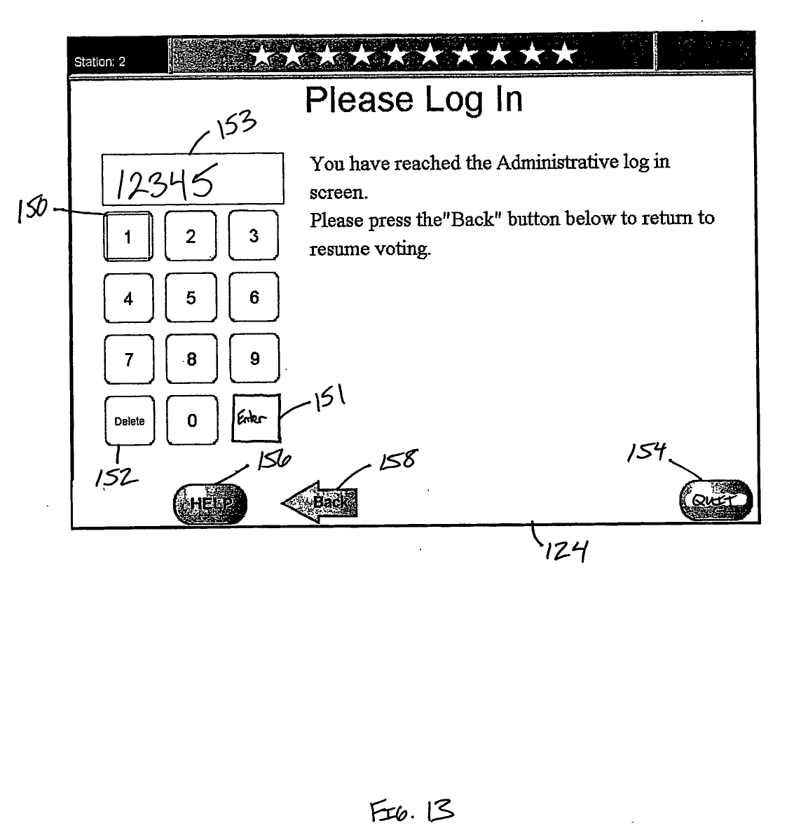

FIG. 12 is a sample screen shot of the PIN number login screen 122 provided on an embodiment of the voting stations of the present invention. The PIN number login screen 122 is where a voter enters the PIN number from his/her voter security card into the system in preparation for voting. A sample voter security card 141 is displayed on the PIN number login screen 122. The voter security card 141 includes a unique voter number 143 and PIN number 145 that is issued to the voter by election officials when the voter entered the polling place and has his/her voter registration verified. On this screen 122, a voter can preferably select one of the number buttons 136 to enter a number in the entry field 137, select Delete 138 to erase the last digit in the entry field, select Enter 139 to process the number in the entry field, select the title side area 142 to display the administrative login screen 124, select Help 144 to go to the system help screen, or select Quit 140 to end the voting session. After the user selects Enter 139, the system makes two checks. First, the system checks if the number in the entry field is the PIN that corresponds to the voter number entered on the previous voter number login screen. If the ID/PIN combination is not valid, the system displays an error message box. When the user selects Ok, the system closes the box and returns to the PIN login screen. If it is valid, the system proceeds to the next check. The system then checks if the ID/PIN combination has already been used to successfully cast a vote. If a vote has been cast using this ID/PIN combination, the system displays a message screen saying that the user has already voted. The system then displays a Begin screen 112 after a short delay. If a vote has not been cast using this ID/PIN combination, the system displays the first voting screen.

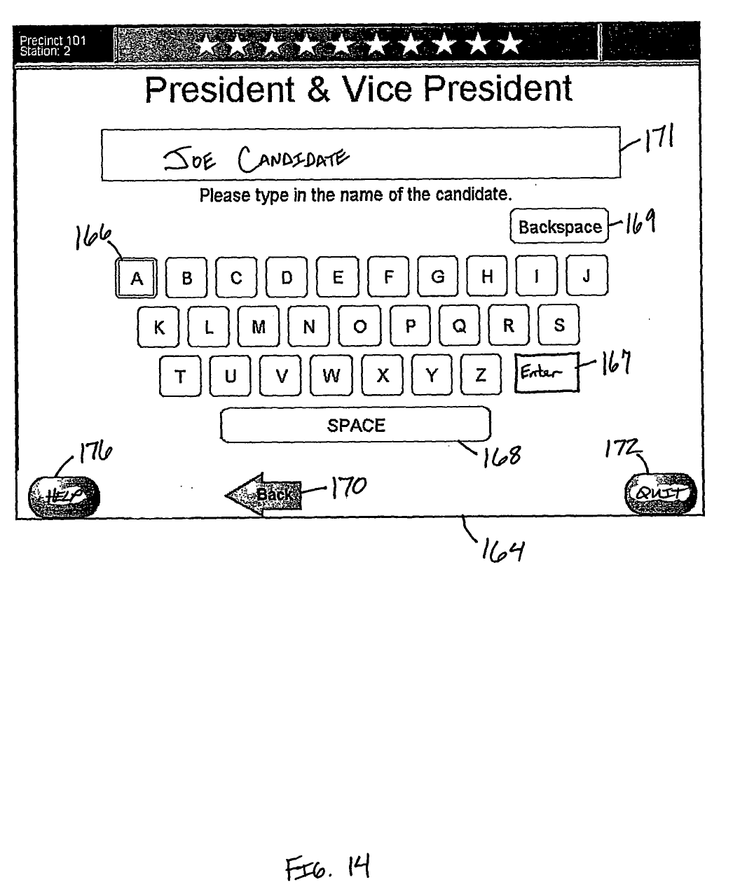

FIG. 13 is a sample screen shot of the administrative login screen 124 provided on the voting stations of the present invention. The administrative login screen 124 is where a user can preferably enter a basic administrator password to access the basic administrative functions, or an advanced administrator password to access all administrative functions. On this screen 124, a user can select one of the number buttons 150 to enter a number in the entry field 153, select Delete 152 to erase the last digit in the entry field, select Enter 151 to process the number in the entry field, select Help 156 to go to the system help screen, select Back 158 to display the voter number login screen 118, or select Quit 154 to end the voting session. After the user selects Enter 151, the system checks if the number is the basic administrator password or the advanced administrator password. If it is the basic administrator password, the system displays a basic administration screen 160. If it is the advanced administrator password, the system displays a advanced administration screen 162. If it is not either password, the system displays the voter number login screen 118.

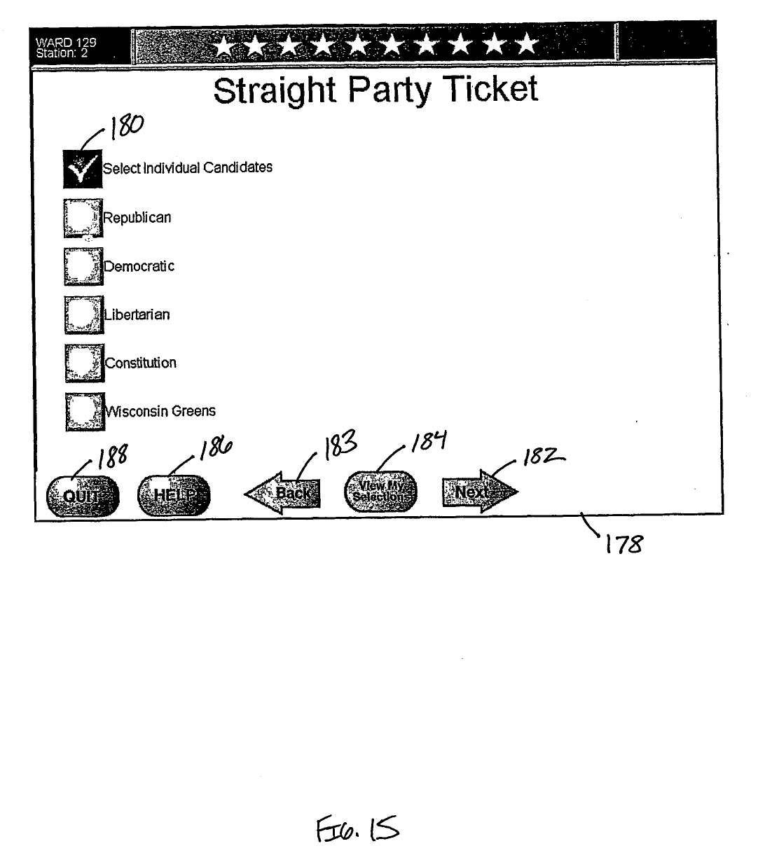

FIG. 14 shows a sample screen shot of a keyboard screen 164 of the present invention. On the keyboard screen 164, a user can select the keyboard letters 166 and space buttons 168 to enter a name into the entry field 171, select Backspace 169 to erase the last character entered in the entry field, select Enter 167 to process the name in the entry field, select Help 176 to go to the system help screen, select Back 170 to display the voter number login screen 118, or select Quit 172 to end the voting session.

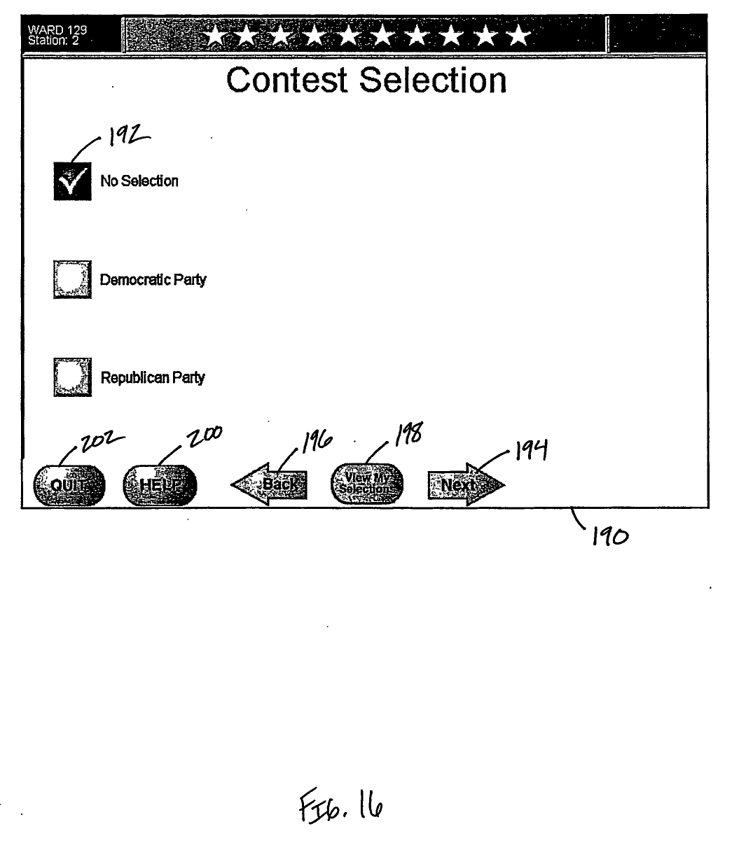

FIG. 15 shows a sample screen shot of a straight party ticket screen 178 of the present invention. The straight party ticket screen 178 allows a user to make selections in multiple races at once by making all selections based on a specific political party. On the straight party ticket screen 178, the user can select an option button 180, select Next 182 to process the user's selection and proceed to the first race screen, select View My Selections 184 to go to the ballot screen, select Back 183 to display the voter number login screen 118, select Help 186 to go to the system help screen, or select Quit 188 to end the voting session. If the Select Individual Candidates option button is selected, the system displays the next race screen on the ballot. If one of the party option buttons is selected, the system creates a straight party ballot by making an automatic selection in each race for the selected party. If the race is a party race and the race includes a candidate from the selected party, the system selects the candidate. If the race is a party race, but the race does not include a candidate from the selected party, the system selects the abstain option. If the race is not a party race, a referendum, for example, no automatic selection is made. When a user votes a straight party ticket, the system does not display any of the party race screens when the user initially navigates through the screens. The user only sees race screens for referendums or other non-party races. After completing all race screens and reaching the ballot screen, the user can access all party race screens using the direct links and therefore modify his/her selections in individual races.

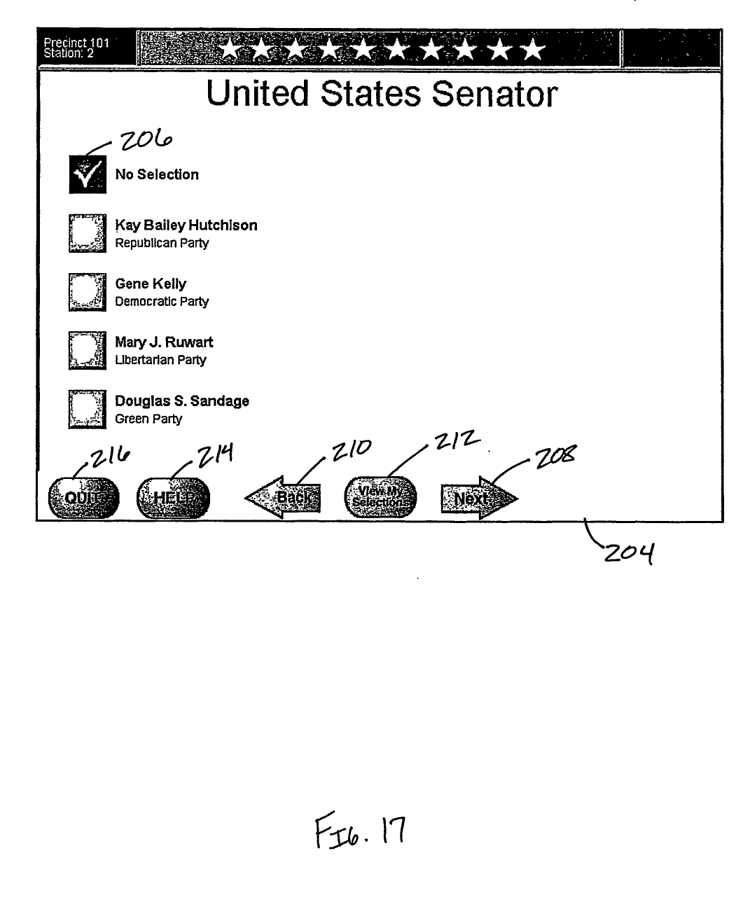

FIG. 16 shows a sample screen shot of a contest selection screen 190 of the present invention. The contest selection screen 190 allows a user to select a ballot based on a specific political party during an open primary election. If a specific political party is selected, the user is presented with race screens for that party as well as non-party race screens, such as a referendum, for example. If no political party is selected, the user is only presented with non-party race screens. On the contest selection screen 190, the user can select an option button 192, select Next 194 to process the user's selection and proceed to the first race screen, select Back 196 to go to the previous contest selection screen, select View My Selections 198 to go to the ballot screen, select Help 200 to go to the system help screen, or select Quit 202 to end the voting session. If a particular political party option button is selected, the system displays the next race screen on the ballot that applies to the party selected. When all race screens for the selected party are completed, the system displays the non-party race screens. If no particular party is selected, the system displays the non-party race screen on the ballot.

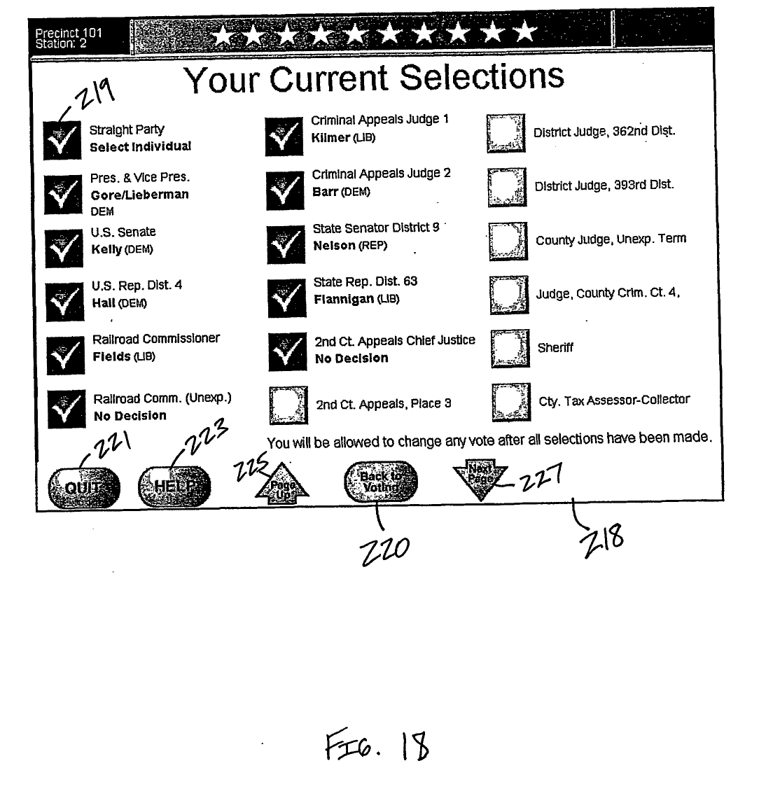

FIG. 17 shows a sample screen shot of a race selection screen 204 of the present invention. Each race on the ballot preferably has its own race screen. A race screen displays all selections that a voter can choose for that race. These selections may be candidates for a political office, decisions on a referendum, or other types of contests as determined by the ballot. For each selection, the screen has an option button 206 and a label identifying the selection. On a race screen, a user can select/unselect option buttons 206, select Next 208 to view the next race screen or the ballot screen if all race screens have been completed, select Back 210 to go to the previous race screen, select View My Selections 212 to display the ballot screen, select Help 214 to go to the system help screen, or select Quit 216 to end the voting session. The system records the user's selections on the ballot screen.

A series of race selection screens display the selections for each race to a voter. The text and options on any given race screen are determined by the ballot for a particular election. The touch screen displays a list of the available candidates to a voter. When voting, a voter is given multiple candidate names or other options on each screen. A race generally has one option button for each choice on the ballot, as well as a write-in option button and an abstain button, typically labeled “No Candidate” or “No Decision”. The write-in option button provides voters the opportunity to specify a candidate not listed on the ballot. When a write-in option button is selected, the system displays the keyboard screen to allow the voter to enter a name. Each candidate in a race has an option button associated with it that voters select to indicate the candidate they want to vote for. The user indicates his/her selection by selecting the option button next to he appropriate name. The voter can also review and make changes to the ballot before casting his/her final vote.

Option buttons function differently depending on whether the race is a single-seat or multi-seat race. A single-seat race is one where a voter is only allowed to select one option at a time. In a single-seat race, selecting an option button selects that button and deselects all other option buttons. If an option button is already selected when selected, nothing happens. A multi-seat race is one where a voter is allowed to select multiple options simultaneously. Selecting an unselected option button selects it if the maximum number of options are not currently selected. If the maximum number of selections are currently selected, selecting an unselected option button does nothing. Selecting a selected option button unselects it.

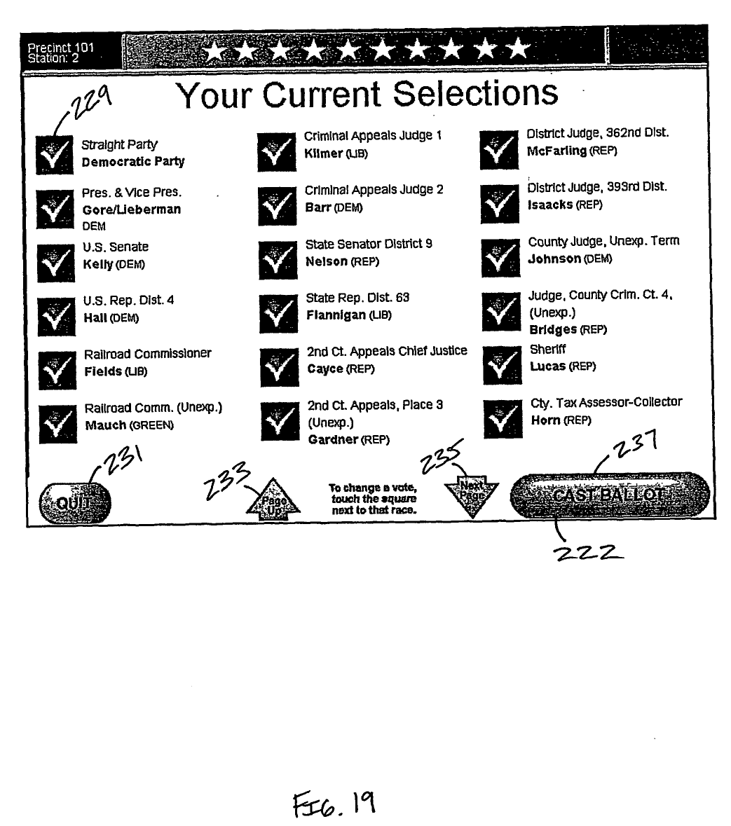

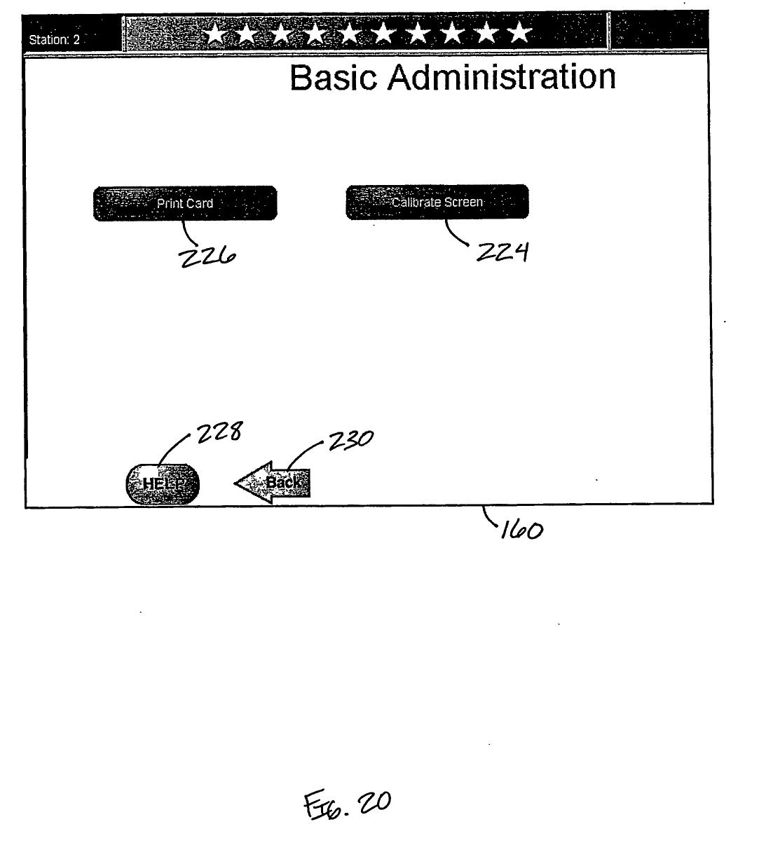

FIGS. 18 and 19 show sample screen shots of a ballot screen 218, 222 of the present invention before, FIG. 18, and after, FIG. 19, completing the ballot. The ballot screen displays the voter's current ballot. The voter can review, change, or cast his/her ballot from the ballot screen. The ballot screen enables a user to review all selections made, make changes to the selections, and cast the final vote. Before a user has completed each race screen, the ballot screen 218 includes a Back to Voting button 220 to go back to the last race screen the user was on prior to accessing the ballot screen. The user must complete all race screens before making changes or casting the final voter ballot. After a user has completed each race screen, the user may return to any race screen by selecting the corresponding race button or select Cast Ballot 237 to cast the final ballot. After casting the final ballot, the system stores the user's ballot in a database, recording the user's choice for each race on the ballot, creates an image file of the ballot screen, creates a text file of the selected options, increments the public and protected counters by one, records the ID/PIN combination used to log in for this session has been used to successfully cast a vote. The same ID/PIN combination can no longer be used to log in to the system. The system displays a message screen informing the voter that his vote has been cast, and returns to the begin screen after a short delay.

In the present invention, multiple copies of election records are preferably saved simultaneously to the system hard drive and subsequently backed-up onto a removable disk, ensuring the safety of the election data. The system keeps an audit trail of an election by creating two different electronic copies of each voter's final ballot and recording them on the system hard drive and on a removable disk. After a ballot is cast, the system preferably records a screen capture of the final ballot screen, which displays the voter's selections in each race. The system also preferably writes the text on the ballot screen to a text file. This text file also records all of a voter's selections in each race. In other words, the system preferably keeps a database record of each ballot cast, an image file of the vote summary screen records all voter selections for each ballot when the voter casts his or her vote, a text file of the information on the vote summary screen, and a running system activity log that notes the date and time of each system action taken over the course of the entire voting session. These files are saved on the hard drive and a removable disk.

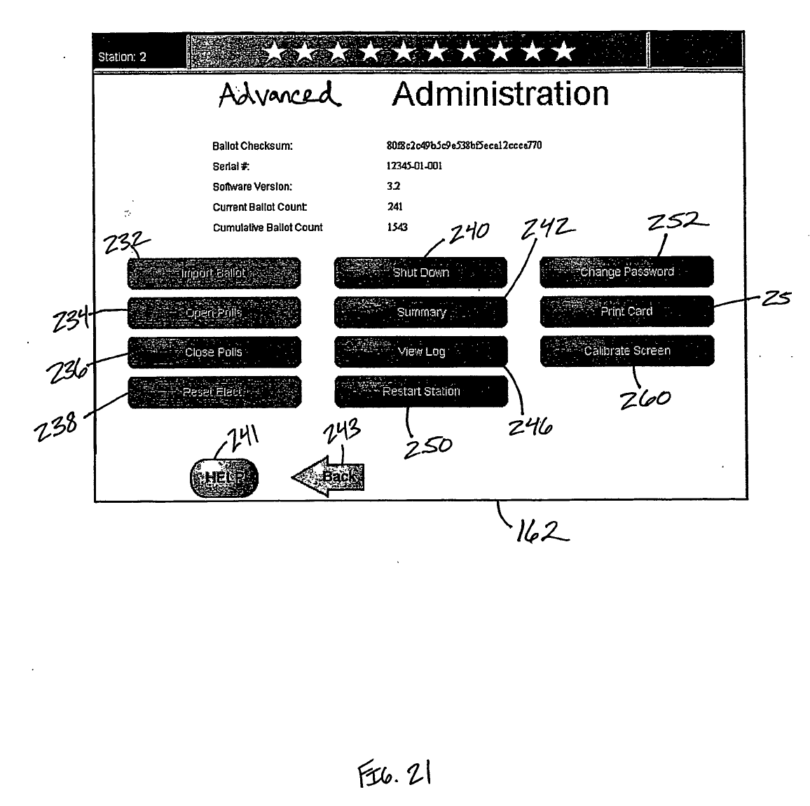

FIG. 20 shows a sample screen shot of the basic administration screen 160 of the present invention. The basic administration screen 160 preferably provides access to two administration functions used for troubleshooting, Calibrate Screen 224 and Print Card 226. Accessing the basic administration screen 160 requires an administration password. A user may select Calibrate Screen 224 to recalibrate the touch screen or select Print Card 226 to go to the voter security card generator screen, select Help 228 to go to the system help screen, or select Back 230 to go to the voter number login screen.

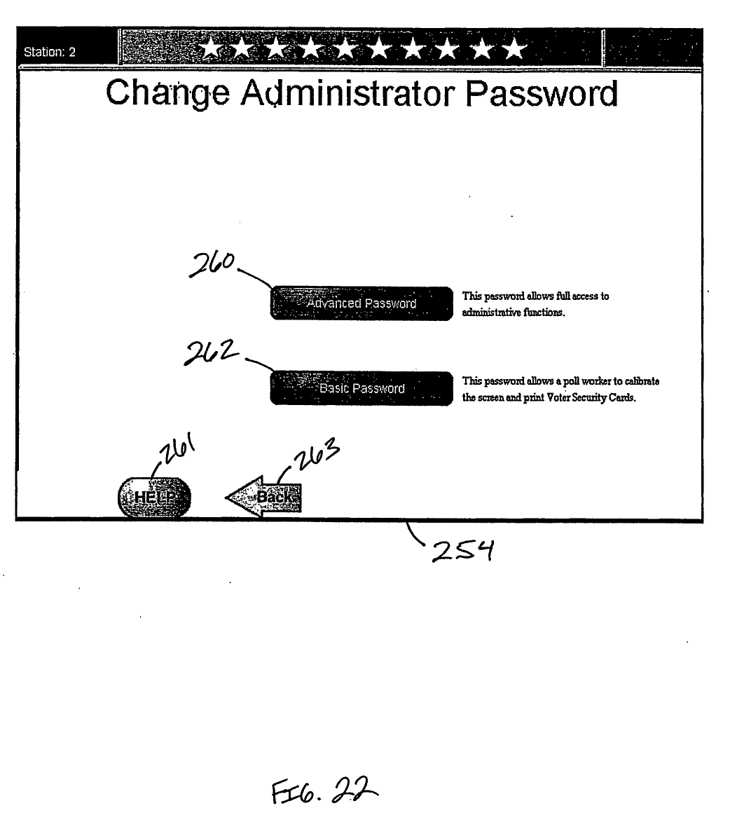

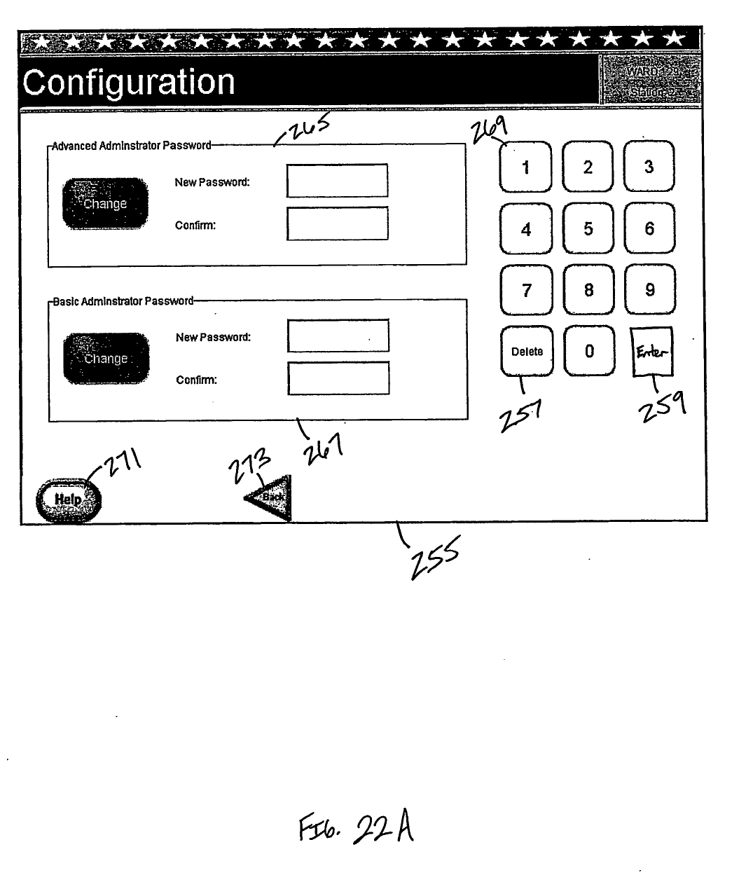

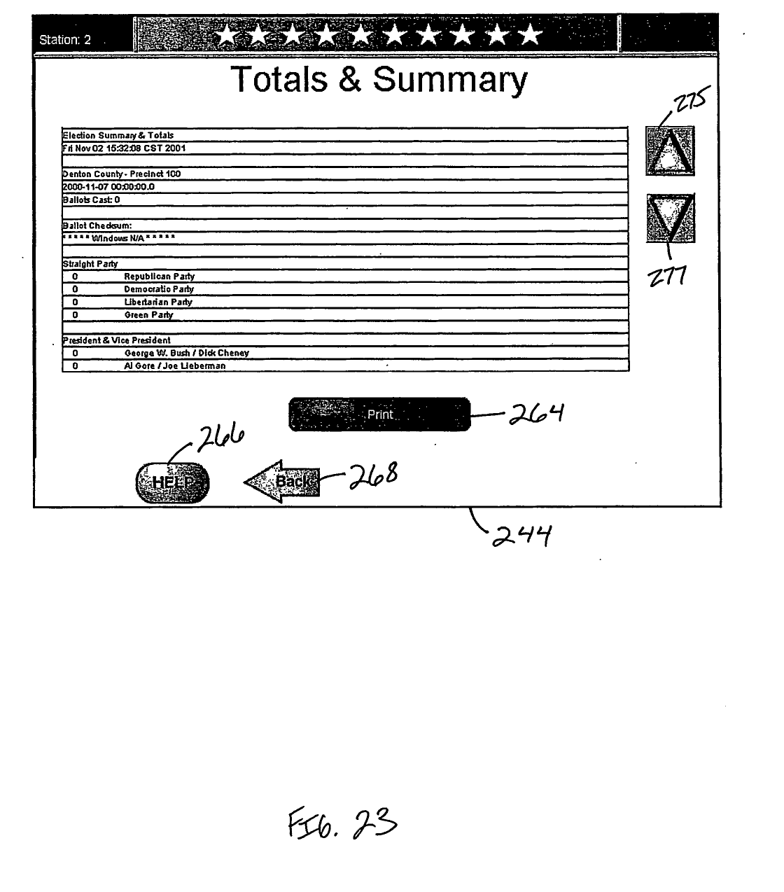

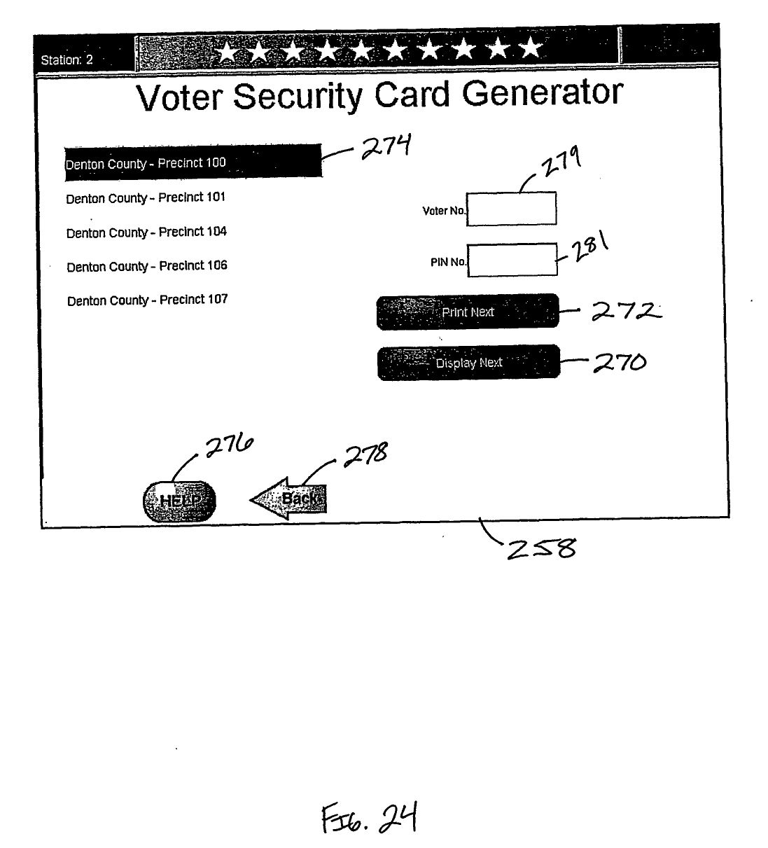

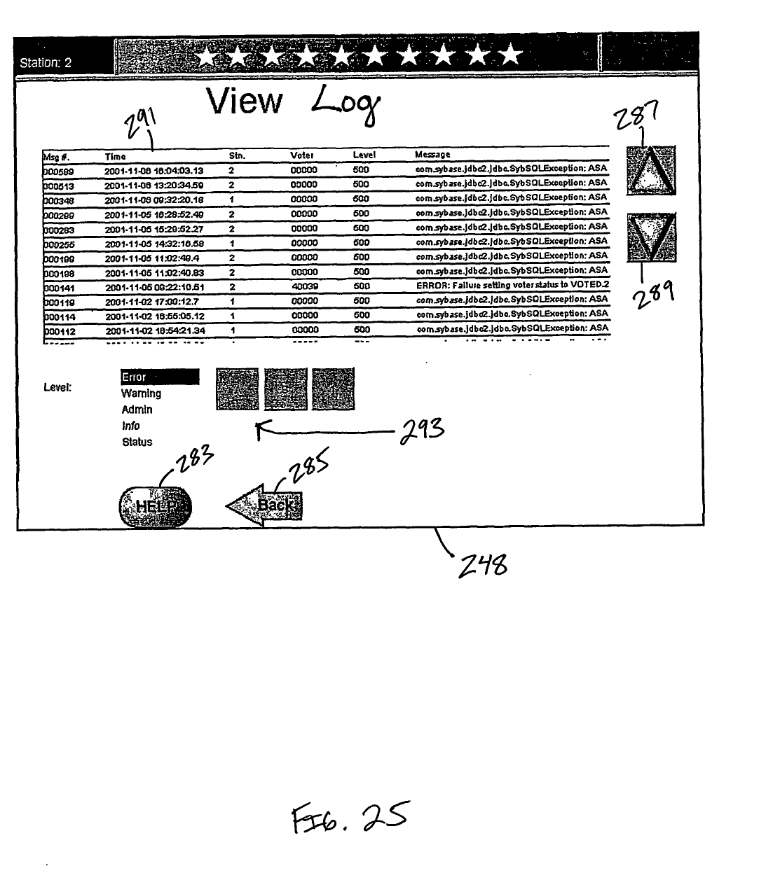

FIG. 21 shows a sample screen shot of the advanced administration screen 162 of the present invention. The advanced administration screen 162 preferably provides access to all administration functions on the system. Accessing the advanced administration screen 162 requires an advanced administration password. The administration functions accessible through the advanced administration screen include Import Ballot 232, Open Polls 234, Close Polls 236, Reset Election 238, Shut Down 240, Summary 242, View Log 246, Restart Station 250, Change Password 252, Print Card 256, and Calibrate Screen 260. A user may select Import Ballot 232 to prepare the system for an election by loading a new ballot from a removable disk. The system loads the ballot from the removable disk, builds the election database, and changes the system mode from a blank mode to a pre-election mode. The Open Polls button 234 is enabled. A user may select Open Polls 234 to enable voting on the system, the system mode is changed from pre-election to voting, and a summary report is automatically generated showing “zero” values for each ballot. The Open Polls button 234 is now disabled and the Close Polls button 236 and the Print Card button 256 are now enabled, A user may select Close Polls 236 to end voting, the system mode changes from voting to post-election. The Close Polls 236 and Print Card 256 buttons are now disabled, and the Reset Election button 238 is enabled. A user may select Reset Election 238 to write the election database, ballot files, and election consolidation summary file to a removable disk and print the post-election summary report. A user may select Shut Down 240 to exit and shut down the system When a user next activates the system and displays the advanced admin ion screen, the Reset Election button 238 is disabled, and the Import Ballot button 232 is enabled. A user may also select Summary 242 to go to the totals and summary screen 244 shown in FIG. 23. A user may also select View Log 246 to go to the view log screen 248 shown in FIG. 25. A user may select Restart Station 250 to view the system status and restart a particular touch screen voting station. Restart Station 250 allows a user to restart the touch screen at any voting station. On the restart station screen, a user may select one of the voting stations in the list to select it. Selecting the restart button restarts the touch screen in the selected voting station. A user may select Change Password 252 to go to the change administrator password screen 254 shown in FIG. 22. A user may also select Print Card 256 to go to the voter security card generator screen 258 shown in FIG. 24. A user may also select Calibrate Screen 260 to re-calibrate the touch screen.

As mentioned above, the system of the present invention preferably has four operating modes, These modes are blank, pre-election, voting, and post-election. The blank mode is for a new system or a system that was reset after a previous election. In this mode, administrative functions can be used, but since a ballot has yet to be loaded onto the system, there is no election data. The system is in blank mode upon initial startup or after a reset election administrative function. Importing a ballot places the system in a pre-election state. The database exists and a preliminary election report can be run, but voting cannot begin until the polls are opened. The system moves to pre-election mode when a user activates the import ballot administrative function. Opening the polls places the system in a voting mode. In this mode, voter security cards may be generated, voters may log in and cast ballots, and voting may continue until the polls are closed. The system moves to voting mode when a user activates the open polls administrative function. Closing the polls places the system in a post-election mode. No voting may take place, and an election report may be run off of the now-complete election database. The system remains in this mode until it is reset. The system moves to post-election mode when a user activates the close polls administrative function.

FIG. 22 shows a sample screen shot of the change administrator password screen 254 of the present invention. This screen 254 can be viewed by using the change password function on the advanced administration screen 162. The change administrator password screen 254 allows a user to change the basic administrator password and the advanced administrator password. Selecting one of the password buttons 260, 262 to initiate a password change initiates a pop-up window with a numeric keypad to change the password. To change a password, the user must first confirm the existing administrator password by entering it on the keypad 269 as shown in the configuration screen 255 of FIG. 22A. The user may then enter and confirm the new password.

FIG. 23 shows a sample screen shot of the totals and summary screen 244 of the present invention. The totals and summary screen 244 displays all current election counts. This screen 244 can be viewed by using the summary function on the advanced administration screen 162. A user may review the election summary by scrolling through the contents of the totals and summaries, or print a copy of the complete election summary on the PIN printer by selecting Print 264. Selecting Help 266 sends you to the system help screen and selecting Back 268 sends you to the advanced administration screen.

FIG. 24 shows a sample screen shot of the voter security card generation screen 258 of the present invention. This screen is only available when the polls are open. This screen 258 can be viewed by using the print card function on the advanced administration screen 162. This screen 258 allows an election official to generate a new voter security card, either on-screen by selecting Display Next 270, or from the PIN printer by selecting Print Next 272 for each registered voter coming to the polls to vote. This screen 258 also allows the election official to select the correct ballot 274 with which the voter security card is to be associated. Selecting Help 276 sends you to the system help screen and selecting Back 278 sends you to the advanced administration screen.

FIG. 25 shows a sample screen shot of the view log screen 248 of the present invention. The view log screen 248 displays a system activity log. This screen 248 can be viewed by using the view log function on the advanced administration screen 162. System errors, warnings, administration, information and status events that may be of interest to administrators or require human intervention to resolve are captured and stored in the system log. System errors that may prevent the system from operating are identified by messages printed on the PIN printer. Selecting an option in the level list permits the user to choose the types of events displayed in the system log text area. Selecting a station selection button permits the user to view the system activity generated from the selected voting station or stations. Selecting Up or Down arrows 287, 289 permits the user to scroll through the contents of the system log text area Selecting Help 283 permits the user to go to the system help screen. Selecting Back 285 permits the user to go to the advanced administration screen.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention.

1. An electronic voting system comprising:
a voting server;
a voter security card station;
a plurality of voting stations;
wherein the voter security card station and the plurality of voting stations are coupled to the voting server either directly or via at least one hub, the voting stations running simultaneously on the voting server and functioning independently of each other; and
software loaded on the voting server for operating and controlling the voting system.

2. The voting system of claim 1 wherein the voting server comprises a motherboard with at least one processor and memory, at least one hard drive, at least one disk drive, at least one power supply, and a plurality of video boards installed within an enclosure.

3. The voting system of claim 2 wherein the plurality of video boards are installed within an expansion slot in the enclosure and allow for simultaneous control of the plurality of voting stations while functioning independently of each other.

4. The voting system of claim 1 further comprising a software key coupled to the voting server or one of the hubs to prevent the system from operating if the key is not plugged in to a USB port.

5. The voting system of claim 1 wherein the voter security card station comprises a printer, for creating voter security cards, each with a unique voter number and PIN, for each registered voter to log onto the system and vote.

6. The voting system of claim 5 wherein the printer is also used to print opening and closing election reports.

7. The voting system of claim 1 wherein the voter security card station comprises a printer and at least one input device for creating voter security cards, each with a unique voter number and PIN, for each registered voter to log into the system and vote.

8. The voting system of claim 7 wherein the printer is also used to print opening and closing election reports.

9. The voting system of claim 7 wherein the input device is a touch screen monitor.

10. The voting system of claim 7 wherein the input device is a monitor with a keyboard.

11. The voting system of claim 7 wherein the input device is a mouse.

12. The voting system of claim 1 wherein the voter security card station comprises a printer, at least one input device and a monitor for creating voter security cards, each with a unique voter number and PIN, for each registered voter to log into the system and vote.

13. The voting system of claim 12 wherein the printer is also used to print opening and closing election reports.

14. The voting system of claim 12 wherein the monitor is a touch screen monitor.

15. The voting system of claim 12 wherein the input device is a mouse.

16. The voting system of claim 12 wherein the input device is a keyboard.

17. The voting system of claim 1 wherein the plurality of voting stations comprise touch screen monitors that voters use to log onto the system using their voter security cards and cast their votes.

18. The voting system of claim 1 wherein the plurality of voting stations comprise monitors and input devices that voters use to log onto the system using their voter security cards and cast their votes.

19. The voting system of claim 1 wherein the at least one hub is preferably a USB hub for connecting the components of the system together.

20. The voting system of claim 2 further comprising a UPS power supply for backing up the power supply.

21. The voting system of claim 1 wherein the software comprises an administrative application program used by election officials for controlling and monitoring operation of the system and a voting application program used by voters for casting votes on an election ballot.

22. The voting system of claim 21 wherein the administrative application comprises setup functions, opening functions, monitoring functions, and closing functions accessible only by election officials with administrator passwords.

23. The voting system of claim 22 wherein the administrative application allows election officials to set up the system for voting, create an opening election report, open the polls, determine a ballot count, run troubleshooting functions, close the polls, and create a closing election report.

24. The voting system of claim 21 wherein the voting application comprises voting ballots and voting functions used by voters to enter their votes into the system, such as allowing a voter to securely log on, enter, review and cast their votes.

25. The voting system of claim 24 wherein the voting application presents a ballot to a voter through a series of screens on the voting stations, at least one screen for each race in an election, whereby the voter makes a voting selection and after voting is complete, the voter can review and modify the selections prior to casting a final vote.

26. The voting system of claim 24 wherein the voting application further comprises a voting interface providing the option of making a straight party vote, an abstain option, selection of multiple candidates, and a write-in option.

27. The voting system of claim 21 wherein the software further comprises a startup program, at least one application program, a database to store ballot information and vote totals, a first shared library program to handle a software key that includes a protective counter and is required to use the system, a second shared library program to process system server operation requests, and a serial communication library program for communicating with the other components of the system.

28. The voting system of claim 21 wherein the votes cast by a voter are stored in a database on the hard drive and written to a removable disk in the disk drive.

29. The voting system of claim 28 wherein the screen image of a ballot is captured and stored on the hard drive and written to a removable disk in the disk drive for possible comparison of what is written in the database ensuring auditability of election results.

30. The voting system of claim 28 wherein the individual votes, election data and summaries are simultaneously written to the hard drive and removable disk in the disk drive, the removable disks being collected and read at a central location for tallying the election results.

31. An electronic voting system comprising:
a voting server coupled to a computer network comprising a voter security card station and a plurality of voting stations, wherein the voter security card station and the plurality of voting stations are coupled to the server either directly or via at least one hub; and
software for operating and controlling the voting system.

32. The voting system of claim 31 wherein the voter security card station comprises a computer workstation, a printer, and a pointing device for creating voter security cards, each with a unique voter number and PIN, for each registered voter to log into the system and vote.

33. The voting system of claim 32 wherein the printer is also used to print opening and closing election reports.

34. The voting system of claim 31 wherein the plurality of voting stations comprise computer workstations with monitors, and/or input devices.

35. The voting system of claim 31 wherein the software comprises a voting application loaded and an administrative application loaded on the voting server.

36. The voting system of claim 35 wherein the voting application comprises voting ballots and voting functions used by voters to enter their votes into the system, such as allowing a voter to securely log on, enter, review and cast their votes.

37. The voting system of claim 36 wherein the voting application presents a ballot to a voter through a series of screens on the voting stations, at least one screen for each race in an election, whereby the voter makes a voting selection and after voting is complete, the voter can review and modify the selections prior to casting a final vote.

38. The voting system of claim 36 wherein the voting application further comprises a voting interface providing the option of making a straight party vote, an abstain option, selection of multiple candidates, and a write-in option.

39. The voting system of claim 35 wherein the administrative application comprises setup functions, opening functions, monitoring functions, and closing functions accessible only by election officials with administrator passwords.

40. The voting system of claim 36 wherein the votes cast by a voter are stored in a database on the hard drive and written to a removable disk in the disk drive.

41. The voting system of claim 36 wherein a screen image of a ballot is captured and stored on the hard drive and written to a removable disk in the disk drive for possible comparison of what is written in the database ensuring auditability of election results.

42. The voting system of claim 36 wherein the individual votes, election data and summaries are written to the hard drive and removable disk in the disk drive, the removable disks being collected and read at a central location for tallying the election results.

43. A computerized electronic voting system comprising:
a computer;
a voter security card station coupled to the computer; and
a plurality of voting stations coupled to the computer and the voter security card station, and controlled by software loaded on the computer, the software providing a voting application for voters to vote on the voting stations and an administration application for election officials to control and monitor the voting process.

44. An electronic voting system comprising:
at least one voting station coupled to a voting server; and
software loaded on the voting server for operating and controlling the voting system.

45. The voting system of claim 44 further comprising an input device coupled to the voting station.

46. The voting system of claim 44 wherein the voting station includes a speech recognition device coupled thereto.

47. The voting system of claim 44 wherein the software includes speech recognition software.

48. A method of computerized voting on an electronic voting system, the method comprising the steps of:
providing a voter security card for each registered voter from a voter security card station, the voter security card having a unique voter number and PIN for each registered voter to log onto a voting station and vote;
providing a plurality of voting stations coupled to the voter security card station and coupled to a computer for voting, the plurality of voting stations running simultaneously on the computer and functioning independently of each other; and
providing software loaded on the computer which includes a voting interface that presents a ballot to a voter through a series of screens on the voting stations, at least one screen for each race in an election, whereby the voter makes a voting selection and after voting is complete, the voter can review and modify the selections prior to casting the final vote.

49. A method of voting on an electronic voting system, the method comprising the steps of:
providing a registered voter with access to a ballot;
providing software loaded on a server which includes a voting interface that presents the ballot to the registered voter through a series of screens on a computer, at least one screen for each race in an election, whereby the registered voter makes voting selections and after voting is complete, the registered voter can review and modify the selections prior to casting the final vote;
securely encoding the completed ballot with the voter's selections and storing the selections electronically; and
sending the completed ballot with the voter's encoded selections to an appropriate elections office.

50. The method of voting on an electronic voting system of claim 49 wherein the registered voter requests a ballot from the appropriate elections office.

51. The method of voting on an electronic voting system of claim 50 wherein the registered voter receives an Internet address and a unique voter number and PIN from the elections office for accessing the ballot over the Internet.

52. The method of voting on an electronic voting system of claim 49 wherein the registered voter prints the completed ballot with the voter's encoded selections.

53. The method of voting on an electronic voting system of claim 49 wherein the elections office scans the completed ballot and counts the votes using the software.

54. The method of voting on an electronic voting system of claim 53 wherein the scanned completed ballot and votes are stored in memory.

55. The method of voting on an electronic voting system of claim 53 wherein the scanned completed ballot and votes are stored on a removable disk.
